(19) United States
(12) Patent Application Publication
(10) Pub. No.: US 2020/0001800 A1
(43) Pub. Date: Jan. 2, 2020

(54) MOTOR VEHICLE PASSENGER COMPARTMENT ASSEMBLY

(71) Applicant: Faurecia Autositze GmbH, Stadthagen (DE)

(72) Inventors: Edgar Karsten, Langenhagen (DE); Christian Neyrinck, Stadthagen (DE)

(73) Assignee: Faurecia Autositze GmbH, Stadthagen (DE)

(21) Appl. No.: 16/452,703

(22) Filed: Jun. 26, 2019

(30) Foreign Application Priority Data
Jun. 27, 2018 (DE) 102018115461.5

(51) Int. Cl. B60R 11/02; B60N 2/02; B60N 2/56; B60J 5/04

(52) U.S. Cl. CPC B60R 11/0264; B60J 5/0416; B60N 2/5607; B60N 2/0224

(57) ABSTRACT

A motor vehicle passenger compartment assembly having at least one electrical load and an operating device that interacts electrically or electronically with the electrical load, which operating device is designed to change the electrical operating state of the electrical load when actuated, the operating device having an operating element that is to be actuated by hand, by an operator, and that is connected to or integrated in an electrically conductive textile element, in particular an electrically conductive woven fabric.

### CROSS REFERENCE TO RELATED APPLICATIONS

This patent application claims priority on and the benefit of German Patent Application No. 10 2018 115 461.5 having a filing date of 27 Jun. 2018.

### BACKGROUND OF THE INVENTION

### Technical Field

The invention relates to a motor vehicle passenger compartment assembly.

### Prior Art

In motor vehicles, electrical loads of all kinds are used, which loads are adjusted, turned on or off, or changed with respect to the operating state thereof in another manner by a vehicle occupant, using operating elements or operating devices. In order to trigger such changes of the operating state of electrical loads in a motor vehicle passenger compartment assembly of this kind, a range of different operating devices are known, for example different switches or also touchpads comprising touch-sensitive, usually capacitively controlled, surfaces. These are generally operating devices which are formed of a relatively stiff material, such that they can also be mounted only on a relatively rigid substrate.

Since, in a motor vehicle passenger compartment assembly, attention is also paid to the ergonomics of operating devices, and since, in addition, a large number of rather soft surfaces comprising covers made of various materials and padding are present therein, rigid operating elements can generally be used only to a very limited extent, owing to the lack of fixing options.

### BRIEF SUMMARY OF THE INVENTION

The object of the invention is therefore that of specifying a motor vehicle passenger compartment assembly which offers advantages compared with the prior art in this respect.

This object is achieved by a motor vehicle passenger compartment assembly comprising at least one electrical load and an operating device that interacts electrically or electronically with the electrical load, which operating device is designed to change the electrical operating state of the electrical load when actuated, wherein the operating device comprises an operating element that is to be actuated by hand, by an operator, and that is connected to or integrated in an electrically conductive textile element, in particular an electrically conductive woven fabric. Advantageous embodiments can be found in the dependent claims.

The motor vehicle passenger compartment assembly comprises at least one electrical load and an operating device that interacts electrically or electronically with the electrical load. Said operating device is designed to change the electrical operating state of the electrical load when actuated. The operating device comprises an operating element that is to be actuated by hand, by an operator, and that is connected to or integrated in an electrically conductive textile element, in particular an electrically conductive woven fabric.

Owing to the use of a textile element, the operating element according to the invention can also be applied to flexible and soft surfaces. In this case, use is made of the effect whereby the electrically conductive textile element both has the required flexibility, and also the electrical resistance of the flexible textile element changes upon deformation, i.e. upon actuation of the operating element, as a result of which said textile element is suitable, owing to the deformation or elongation, for converting the movements, transmitted by the operator to the textile element via the operating element, into electrical switching signals.

For this purpose, the textile element can preferably undergo resilient elongation. For this purpose, a textile element can be selected that comprises integrated electrical conductors which lengthen or shorten, and thus change with respect to the electrical resistance thereof, upon elongation of the textile element.

According to a preferred embodiment of the present invention, in particular a signal terminal or a plurality of first terminals are arranged so as to be remote from the region of the operating element and are electrically connected to the textile element. In this manner, a change in resistance between the region of the operating element and the at least one terminal, upon operation of the operating element, can be recorded, which change can then be used and/or evaluated as a switching signal for an electrical load. It is furthermore preferable, for this purpose, for a second terminal to be arranged in the region of the operating element. A change in resistance can be detected for example by means of voltage tapping between the second terminal and one of the first terminals.

According to a particularly advantageous embodiment according to the invention, an electrical voltage, in particular a DC voltage, is applied between the at least one first terminal and the second terminal. As a result, for example the first terminals function as anodes and the second terminal functions as a cathode. The textile element according to the invention is then conductively connected between the anodes and the cathode.

The first terminal/terminals and/or the second terminal communicates/communicate with, or is/are coupled to, a controller, in particular by means of an amplifier. In this way, the signals can be generated by the actuation of the operating element, and the associated elongation or compression of the textile element, and used to control or actuate an electrical load. There are cases, however, in which it is not possible to use the direct signal, resulting therefrom, as a control signal, because the signal change may be too small. For this purpose, an amplifier can preferably be connected between the operating element and the controller. Amplifying the signals or signal changes caused thereby makes it possible to increase the dynamic range and to thus also improve the resolution of the operating device. In particular, thresholds can also be set, or can be set better, below which thresholds operation of the operating element does not result in control of the electrical load. This may be expedient for example in the event of short, accidental, and thus unintentional, contacting of the operating device according to the invention.

In the case of a configuration of this kind, it may in particular be possible for the controller to be designed to record the electrical resistance, the electrical voltage and/or the electrical current, and/or the change in said variables, in particular in the textile element between the region of the operating element, in particular the second terminal, and at least one first terminal.

According to a preferred embodiment of the present invention, the controller communicates with the electrical load and is designed to output, on the basis of the recorded value for the electrical resistance, the electrical voltage and/or the electrical current, and/or a change in said variables, a control signal for changing the operating state of the load communicating with the controller. In order to generate a control signal, it is thus possible to record both (differential) changes or also absolute measured values upon actuation of the operating element. What variables are recorded, and in what manner—relative or absolute—depends on the intended manner of actuation of the electrical load that is to be actuated.

In order to make the operating element according to the invention even less susceptible to operating errors, in particular those in which the finger of the vehicle occupant does not contact the operating element, it may be possible for the operating element to comprise a capacitive sensor. A capacitive sensor of this kind can then discern whether the contact with the operating element is made by the human hand or by another object. As a result, accidental contact by objects that enter the reach of the operating element cannot result in unintentional actuation of an electrical load.

The operating element according to the invention can be used in various manners within the motor vehicle passenger compartment assembly. For example, the motor vehicle passenger compartment assembly according to the invention may comprise a motor vehicle door and/or a motor vehicle seat and/or a console and/or a dashboard, on which the operating element is arranged.

The number and type of the electrical loads that can be addressed by the operating device according to the invention are at the discretion of a person skilled in the art. For example, it may be possible for the at least one electrical load to be selected from the following group: motor vehicle seat adjuster, window lifter, on-board computer, heater, air-conditioning system, entertainment system, light.

### BRIEF DESCRIPTION OF THE DRAWINGS

The invention will be explained in greater detail in the following, with reference to FIGS. 1-6C:

FIG. 1 is a side view of the operating panel of an operating device according to the invention for a motor vehicle passenger compartment assembly according to the invention.

FIG. 2 is a plan view of an operating device from FIG. 1.

FIG. 3 shows actuation, by way of example, comprising deflection of the operating element in the Y-direction.

FIG. 4 shows an example for the metrological recording of a signal of the operating device.

FIG. 5 is a diagram, by way of example, illustrating the recording of the measuring signals which are forwarded to a control unit.

FIGS. 6A-C show motor vehicle passenger compartment assemblies, by way of example, in which the operating device is arranged on a console (FIG. 6A), on a motor vehicle seat (FIG. 6B), or on a motor vehicle door (FIG. 6C).

### DETAILED DESCRIPTION OF PREFERRED EMBODIMENTS

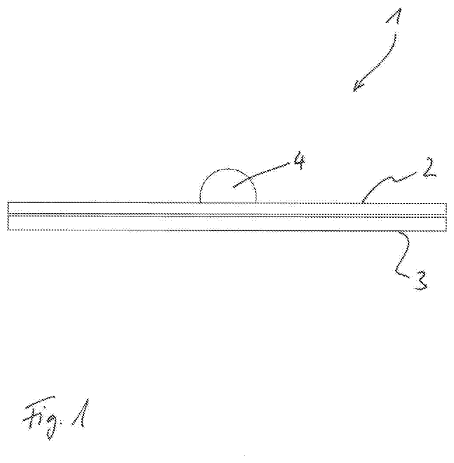

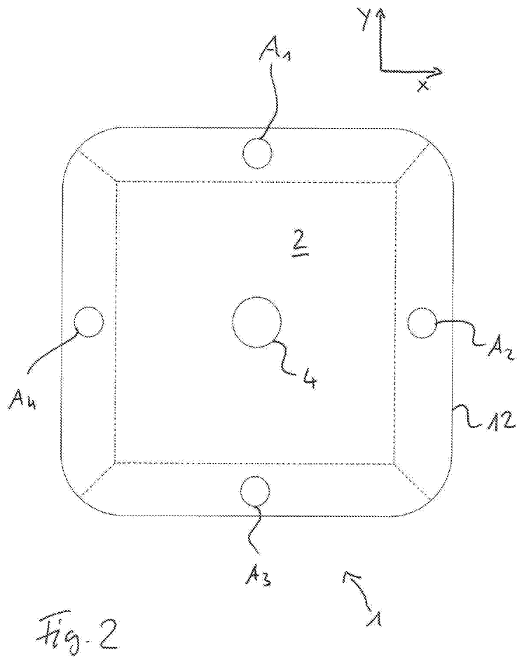

Of the embodiment, shown by way of example in FIG. 1, of the operating device 1 according to the invention for a motor vehicle passenger compartment assembly (not shown), only the operating panel is shown in the side view here. The electrically conductive textile element 2 is laid on the substrate material 3, which consists of any desired, but preferably of a flexible, material, and said textile element can be displaced with respect to the substrate material 3 at least at points. For this purpose, in this example an operating element 4 is arranged on the textile element 2, in particular incorporated in the textile element 2, such that an operator can displace said operating element 4 in terms of the horizontal position X, Y thereof, and thus elongates and/or compresses the textile element 2. The operating element 4 shown here is a round button, but it can also be designed so as to be of any other desired shape. It is likewise conceivable not to use a three-dimensional operating element 4, but instead simply to press a point on the textile element or to make a slight depression in the textile element 2, as a result of which the operator directly contacts the textile element 2 and displaces said element for operating purposes. The textile element 2 is an electrically conductive material, the resistance of which changes by means of elongation and/or compression. The textile element 2 is preferably resilient, such that the operating element 4 returns to the initial position when the operator releases the operating element 4.

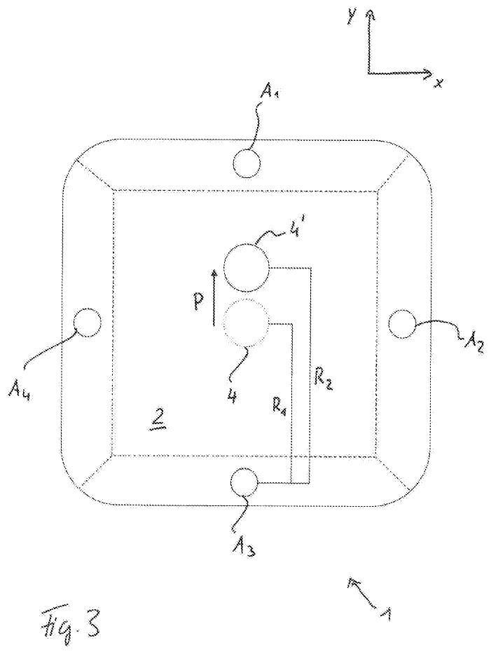

FIG. 2 is a plan view of an operating element 1. The textile element 2 is arranged on the substrate material 3 via the frame 12 comprising the terminals A1-A4, and it thus at least indirectly arranged on the body of the motor vehicle or a component of the motor vehicle that is rigidly connected to the body. As shown in FIG. 1, inside the frame 12 the textile element 2 rests freely on the substrate material 3. A peripheral region in the edge region of the textile element 2, by means of which the textile element 2 is fastened to the substrate material 3 therebelow, can also be considered a frame. It is thus possible to move the operating element 4 relatively freely on the surface X-Y, within the frame 12, and thus generate signals by changing the ohmic resistance, which signals can then later be further processed to form control signals for an electrical load.

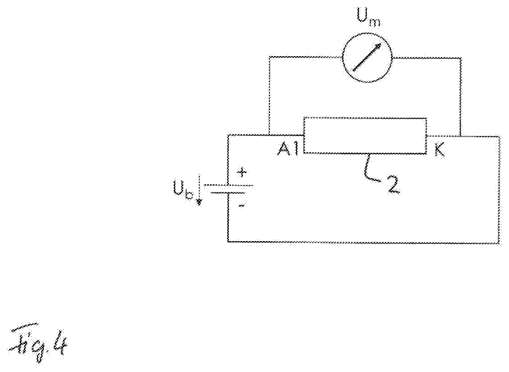

FIG. 3 shows a deflection of this kind. The operating element 4 is deflected, in the direction of the arrow P, into the position 4′. The connection between the terminal A3 and the terminal K (not shown) on/under the operating element 4, 4′ is shown here by way of example. When the operating element 4 is in the neutral position, the textile element 2 has a resistance R₁ between the terminal A3 and the terminal K. If the operating element 4 is then displaced into the position of the operating element 4′, the resistance between the terminals A3 and K thus changes by the magnitude R2. This change is recorded, and the recorded value is directly or indirectly conveyed to a controller 6.

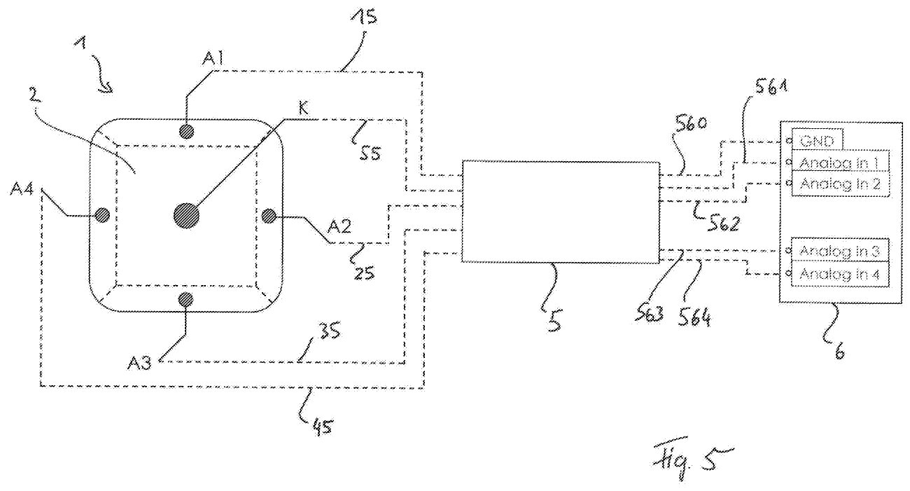

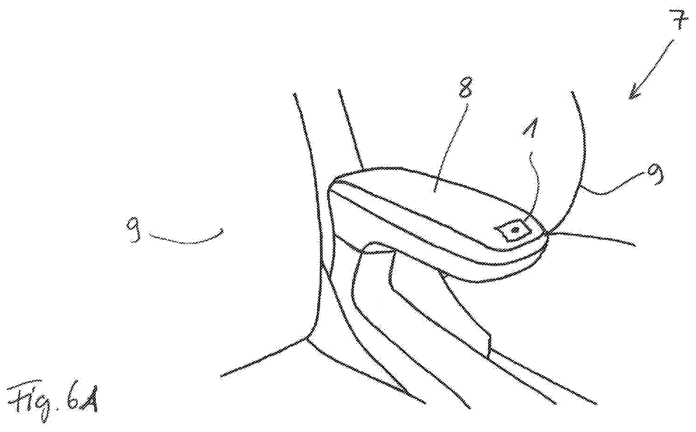

FIG. 4 is a schematic circuit diagram, by way of example, for the measurement process. Here, a voltage U_{b}, in this case a DC voltage, is applied between the terminal A1, which is arranged on the frame 12, and the terminal K, which is arranged on or under the operating element 4. A DC voltage is advantageous insofar as a DC voltage is in any case provided in a motor vehicle, for example via the car battery. In the example shown, the resistance of the textile element 2 between the terminals A1 and K is measured by measuring the voltage drop. The internal resistance of a DC voltage source, which internal resistance is always present, causes the voltage drop over the external resistance between the terminals A1 and K to change when the resistivity changes.

It is also possible, however, to record the current flow between the terminals A1 and K, which current flow also changes as a result of the change in the resistance.

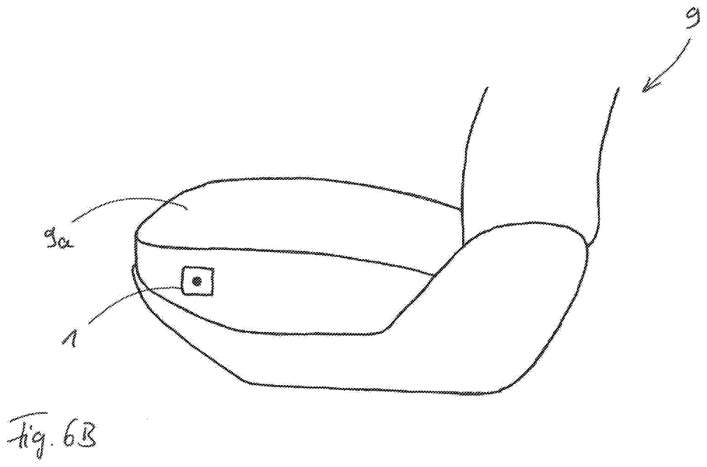

FIG. 5 shows a system for recording the operating signals. Measuring signals are fed from the terminals A1-A4, K to an amplifier 5 via the wires 15, 25, 35, 45, 55. Said signals may for example be voltage signals or current signals. In the simplest case, the amplifier 5 can directly evaluate the signals, or the amplifier 5 is used simply for amplifying the incoming signals and forwards said signals to a controller 6 which generates control signals therefrom. The control signals may be determined from differential measurements for example. In the differential measurements, for example, the currently measured value can be compared with a specified stored inoperative value. In this case, the inoperative value corresponds to the measured value that is acquired when the operating element 4 is located in the initial position, preferably centrally on the operating panel, within the frame 12.

If, as is shown in FIG. 3, the operating element 4 is displaced in the direction P and moved into the position 4′, the textile element 2 is thus elongated between the terminal A3 and the terminal K (under the operating element 4, 4′), and leads to a change in resistance between the two terminals. At the same time, the textile element 2 is compressed between the terminals A1 and K, such that the resistance between A1 and K also changes. In order to determine a control signal, the amplifier 5 and/or the downstream controller 6 can also perform a differential measurement of the voltages or currents both between A3 and K and also between A1 and K, and thus ascertain a signal that is used for actuating an electrical load.

The processed measuring signal is forwarded from the amplifier 5 to a controller 6, via the control wires 560-564. The controller 6 then issues execution commands to the selected electrical loads, according to the input signals. Said selected electrical loads may for example be controllers, actuators, dimmers or other devices. An amplifier 5 is not essential, in the case of the operating device, if the measuring signal from the operating device 1 is sufficiently large or has a sufficient dynamic range for directly supplying the control unit 6. However, since the measuring signals are generally relatively weak, it is recommended to use an amplifier 5 for processing the measuring signals.

The signal acquisition and forwarding by the amplifier 5 and/to the controller 6 may be configured such that execution commands or control signals are output only when the control signal exceeds a specified threshold. As a result, short-term and/or inadvertent contact of the operating element 4 is not used for control purposes. It is also possible to equip the operating device 1, in particular the operating element 4 with a capacitive sensor, for example. Said sensor can ascertain whether the operating element 4 is displaced by an operator or by another object, and thus constitutes an additional safeguard for the operating device 1.

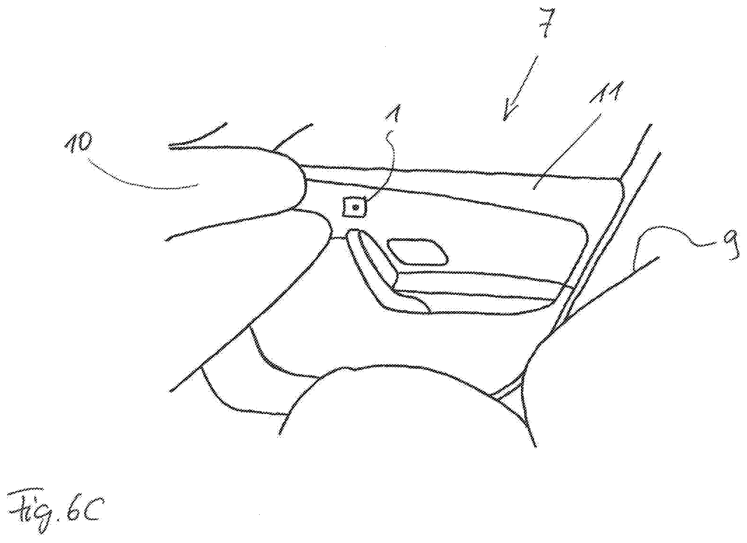

FIGS. 6A-C show some embodiments of subject matter according to the invention.

FIG. 6A shows a console 8 in a motor vehicle passenger compartment assembly 7. In the example, the console 8 is arranged between two motor vehicle seats 9, and is accordingly a central console. An operating device 1 according to the invention is arranged in the upper, front region of the console 8. Depending on the design, an individual electrical load or a plurality of electrical loads can be actuated by means of said operating device 1. It is thus possible, for example, for the on-board computer and/or the heater and/or the air-conditioning system and/or the ventilation and/or the entertainment system and/or the light and/or the mirrors and/or other electrical devices to be controlled.

FIG. 6B shows an operating device 1 which is arranged on a motor vehicle seat 9. In the example shown, the operating device 1 is arranged on the lateral surface of the seat cushion 9a. The seat functions such as the height of the seat cushion 9a, the inclination thereof, the length adjustment of the motor vehicle seat 9, the backrest inclination, the headrest height, the seat heater or other functions are preferably controlled at this point.

FIG. 6C shows a third embodiment of a motor vehicle passenger compartment assembly 7 comprising an operating device 1 whish is arranged on a motor vehicle door 11. The motor vehicle door 11 shown here is a front door, since it is located between the dashboard 10 and a motor vehicle seat 9. The side windows are preferably actuated using an operating device 1 of this kind. It is also conceivable, however, that, in the case of a driver's door (for example a right-hand drive vehicle), the exterior mirrors and/or the door lock may also be actuated using the operating element.

Instead of a door, it is also possible for an inside wall of a motor vehicle to be equipped with the operating device 1 according to the invention.

In a motor vehicle passenger compartment assembly 7 comprising a corresponding operating device 1, the positions shown in FIGS. 6A to 6C are not the only ones possible. In a motor vehicle passenger compartment assembly 7, the operating device 1 can be used wherever an operating device 1 is intended to flexibly adapt to a specified contour and to make it possible to operate a device largely independently of simultaneous eye contact. In this case, the operating device need not necessarily be arranged against or on planar surfaces, but curved surfaces are also conceivable.

1. A motor vehicle passenger compartment assembly (7) comprising at least one electrical load and an operating device (1) that interacts electrically or electronically with the electrical load, which operating device is designed to change the electrical operating state of the electrical load when actuated, wherein the operating device (1) comprises an operating element (4) that is to be actuated by hand, by an operator, and that is connected to or integrated in an electrically conductive textile element (2), in particular an electrically conductive woven fabric.

2. The motor vehicle passenger compartment assembly (7) according to claim 1, wherein the textile element (2) can undergo resilient elongation.

3. The motor vehicle passenger compartment assembly (7) according to claim 1, wherein a signal terminal or a plurality of first terminals (A1-A4) are arranged so as to be remote from the region of the operating element and are electrically connected to the textile element (2).

4. The motor vehicle passenger compartment assembly (7) according to claim 3, wherein a second terminal (K) is arranged in the region of the operating element.

5. The motor vehicle passenger compartment assembly (7) according to claim 4, wherein an electrical voltage (U_{b}), in particular a DC voltage, is applied between the at least one first terminal (A1-A4) and the second terminal (K).

6. The motor vehicle passenger compartment assembly (7) according to claim 4, wherein the first terminal/terminals (A1-A4) and/or the second terminal (K) communicates/communicate with, or is/are coupled to, a controller (6), in particular by means of an amplifier (5).

7. The motor vehicle passenger compartment assembly (7) according to claim 6, wherein the controller (6) is designed to record the electrical resistance, the electrical voltage and/or the electrical current, and/or the change in said variables, in particular in the textile element (2) between the region of the operating element (4), in particular the second terminal (K), and at least one first terminal (A1-A4).

8. The motor vehicle passenger compartment assembly (7) according to claim 7, wherein the controller (6) communicates with the electrical load and is designed to output, on the basis of the recorded value for the electrical resistance, the electrical voltage and/or the electrical current, and/or a change in said variables, a control signal for changing the operating state of the load communicating with the controller.

9. The motor vehicle passenger compartment assembly (7) according to claim 1, wherein the operating element (4) comprises a capacitive sensor.

10. The motor vehicle passenger compartment assembly (7) according to claim 1, further comprising a motor vehicle door (11) and/or a motor vehicle seat (9) and/or a console (8) and/or a dashboard (10), on which the operating element (4) is arranged.

11. The motor vehicle passenger compartment assembly (7) according to claim 1, wherein the at least one electrical load is selected from the group consisting of a motor vehicle seat adjuster, a window lifter, an on-board computer, a heater, an air-conditioning system, an entertainment system, and a light.
